(19) United States
(12) Patent Application Publication
(10) Pub. No.: US 2023/0142339 A1
(43) Pub. Date: May 11, 2023

(54) RECOGNITION OF USER INTENTS AND ASSOCIATED ENTITIES USING A NEURAL NETWORK IN AN INTERACTION ENVIRONMENT

(71) Applicant: Nvidia Corporation, Santa Clara, CA (US)

(72) Inventors: Vlad Getselevich, Los Gatos, CA (US); Purnendu Mukherjee, San Jose, CA (US)

(21) Appl. No.: 17/521,262

(22) Filed: Nov. 8, 2021

(51) Int. Cl. G10L 15/22; G06F 40/295; G10L 15/06; G06N 3/04

(52) U.S. Cl. CPC G10L 15/22; G06F 40/295; G10L 15/063; G06N 3/0454; G10L 2015/0636; G10L 2015/223

(57) ABSTRACT

Systems and methods determine an intent of a received voice input corresponds to an intent label and determine an entity for the intent label. The entity may be responsive to a formulation associated with the intent. A value for the entity may be determined and populated to provide the entity as a command to one or more interaction environments. The interaction environment may execute commands responsive to a user input based on the value associated with the entity.

### BACKGROUND

Interaction environments may include conversational artificial intelligence systems that receive a user input, such as a voice input, and then infer an intent in order to provide a response to the input. These systems are generally trained on large data sets, where each intent is trained to a specific entity, which creates a generally inflexible and unwieldy model. For example, systems may deploy a variety of different models that are specifically trained to each task and when small changes are instituted, the models are then retrained on newly annotated data. As a result, systems may be inflexible to new information or updates may be slow, which could limit the useability of the systems.

### BRIEF DESCRIPTION OF THE DRAWINGS

Various embodiments in accordance with the present disclosure will be described with reference to the drawings, in which:

FIG. 1 illustrates an example interaction environment, according to at least one embodiment;

FIG. 2 illustrates an example of a pipeline for intent and entity recognition, according to at least one embodiment;

FIG. 3A illustrates an example environment for intent recognition, according to at least one embodiment;

FIG. 3B illustrates an example environment for entity recognition, according to at least one embodiment;

FIG. 4 illustrates an example command definition for an interaction environment, according to at least one embodiment;

FIG. 5 illustrates an example process flow for intent and entity recognition, according to at least one embodiment;

FIG. 6A illustrates an example flow chart of a process for intent and entity recognition, according to at least one embodiment;

FIG. 6B illustrates an example flow chart of a process for intent and entity recognition, according to at least one embodiment;

FIG. 6C illustrates an example flow chart of a process for configuring an interaction environment, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

Approaches in accordance with various embodiments provide systems and methods for zero-shot approaches to interaction environments. In at least one embodiment, a zero-shot approach may be utilized for recognition of user intents, for example based a user input, such as an auditory input. Various embodiments may include one or more trained neural network models that receive an input, such as an auditory user query, and determine a label for the associated input that corresponds to an intent of the query. The label may be determined based, at least in part, on a probability the label corresponding to the intent exceeds a threshold. In at least one embodiment, a set of pre-determined labels may be provided, where user inputs are then evaluated against those labels to determine which label is most likely associated with the input. Various embodiments may further utilize one or more approaches, such as a zero-shot approach, to determine an entity associated with the intent of the input. For example, the entity may be determined, at least in part, by defining a question or phrase to describe the entity in a natural way. In various embodiments, an extractive question answer model may be utilized to answer the question or phrase in order to determine a value for a slot associated with an answer to the input.

Various embodiments of the present disclosure may enable one or more conversational artificial intelligence (AI) systems to recognize user commands (e.g., intents and entities) during natural language conversational interactions while providing flexibility for an operator to add new commands without extensive new training examples. Accordingly, embodiments may enable a user who wants to add voice or textual natural language commands to an application to do so without preparing, often manually, thousands of examples and training one or more neural network models for a specific use case. Furthermore, retraining steps may be reduced or eliminated using embodiments of the present disclosure. In at least one embodiment, systems and methods may also enable adding new commands to the system, in near real-time or in runtime.

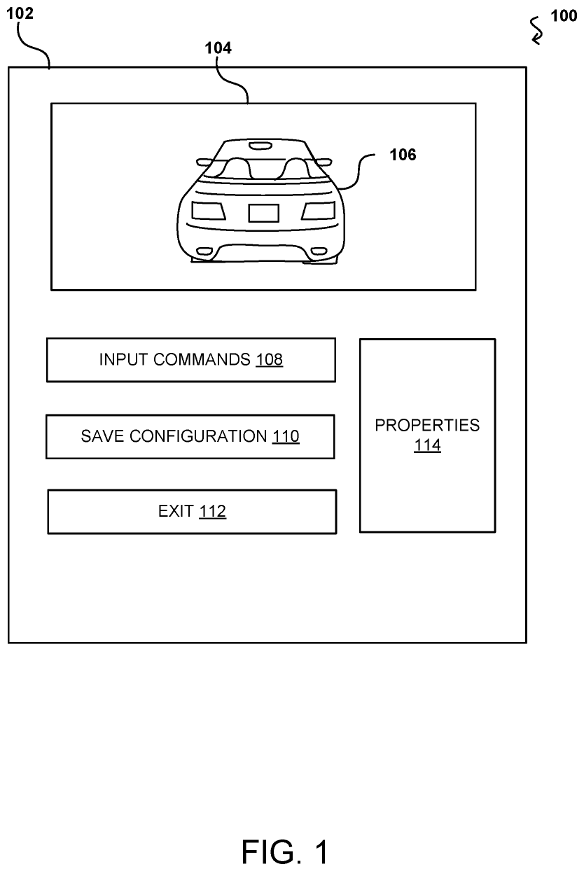

An interaction environment 100 may be presented in a display area 102 that includes one or more content elements, as illustrated in FIG. 1. In at least one embodiment, interaction environment 100 may be associated with a conversational AI system that allows a user to interact with different content elements based, at least in part, on one or more inputs, such as a voice input, a textual input, selection of an area, or the like. The display area 102 may form a portion of an electronic device, such as a smart phone, personal computer, smart TV, a virtual realty system, an interaction kiosk, or the like. In this example, a display element 104 is illustrated that includes an object 106 corresponding to an automobile. The object 106 is illustrated in a rear-view where a bumper is visible. As will be described below, various embodiments enable a user to provide an input instruction, such as a voice instruction, to modify one or more aspects of the object 106 and/or to perform one or more supported actions within the interaction environment 100.

The illustrated system further includes selectable content elements, which may include an input content element 108, a save content element 110, an exit content element 112, and a property content element 114. It should be appreciated that these selectable content elements are provided by way of example only and that other embodiments may include more or fewer content elements. Furthermore, different types of content elements may be utilized with different types of interaction properties, such as voice commands, manual inputs, or the like. Furthermore, the interaction environment may receive one or more scripts that include a sequence of actions that are used to initiate different commands associated with the selectable content elements. In operation, the user may interact with one or more of the content elements in order to perform one or more tasks or actions associated with the environment, such as changing properties of the object 106. By way of example, the user may select the input content element 108, such as by clicking on it (e.g., with a cursor controlled by a mouse or with a finger), by providing a verbal instruction, or the like. The user's command may then be received and one or more systems may determine the user's intent, determine an entity associated with the intent, and then perform one or more actions based, at least in part, on the user input.

Systems and methods may be directed toward generating a conversational AI using a zero-shot approach. Embodiments include a user-defined set of intents that are associated with a label. Each of these intents may have a corresponding question or follow on action, which may then be used to select a value to fill a slot. As an example, a user intent may relate to changing a car color, the corresponding question would be “which color” and the values to fill that slot (e.g., answer the question) could be any number of colors. During operation, a first trained network determines a probability that an input corresponds to a label, with the highest probability being selected, to determine an intent of the input. Then, a second trained network determines a follow on question for that intent to determine which value to populate a slot for the intent. The command may then be executed. The system enables development of a conversational AI with a reduced amount of training data and also provides a more natural way of coding the information because intents and questions may be provided in a natural way.

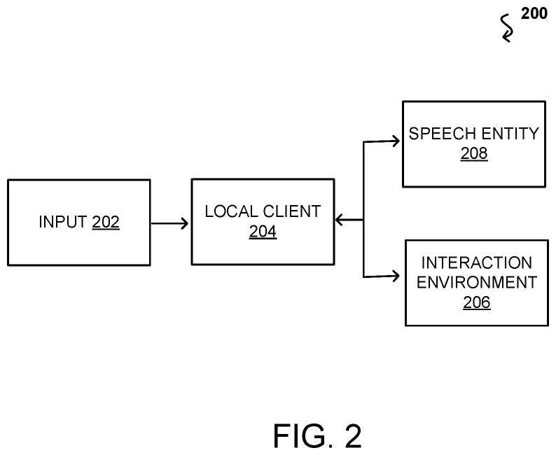

An architecture 200 may include one or more processing units, which may be locally hosted or part of one or more distributed systems, as shown in FIG. 2. In this example, an input 202 is provided at a local client 204. As noted above, the local client 204 may be one or more electronic devices that are configured to receive a user input, such as a voice input, and is communicatively coupled to additional portions of the architecture 200, either through on-system memory or via one or more network connections to one or more remote servers. The input may be a speech input, such as a user utterance that includes one or more phrases, which may be in the form of a question (e.g., query) or a command, among other options. In this example, the local client 204 may provide access to an interaction environment 206. For example, the local client 204 may access, over a network, one or more computing units of a distributed computing environment that may provide access to the interaction environment 206. In various embodiments, the interaction environment 206 may be accessible via one or more software programs stored on and/or executed by the local client 204. By way of example, the local client 204 may include a kiosk positioned to assist individuals navigate an area or to answer questions or queries, the kiosk may include software instructions that are configured to provide users with access to the capabilities of the interaction environment 206.

In operation, the user provides the input 202 to the local client 204, which may further include one or more speech clients to enable processing of the input. By way of example, the speech client may perform one or more pre-processing steps, as well as evaluation of the speech, such as via automatic speech recognition, text-to-speech processing, natural language understanding, and the like. Moreover, it should be appreciated that one or more of these functions may be offloaded to a remote speech entity 208, which may be hosted or otherwise part of a distributed computing environment accessible via one or more networks, or may be, at least in part, stored or executed on the local client 204. The local client 204 may transmit the input to the speech entity 208 for processing, for example as an audio stream. The speech entity 208 may then determine queries, commands, questions, or the like from the audio stream using one or more processing modules.

In various embodiments, the speech entity 204 may further include one or more trained neural network models that enable recognition of an intent or the audio stream, or other input, associated with the input 202. For example, the speech entity 204 may evaluate one or more portions of the audio stream to determine an intent of the audio stream, which may be based, at least in part, on an evaluation of whether the query corresponds to one or more intent labels. Various words or phrases from the audio stream may be evaluated and then a probability of the words or phrases corresponding to a label may be determined, where a highest probability label and/or a label exceeding a threshold and being a highest probability label, may be selected. In at least one embodiment, one or more additional train neural networks, such as an extractive question answer model, may, based at least in part on the intent, determine a follow on question associated with the query. The follow on question may relate to a query that is responsive to query where it is determined whether the follow on question logically follows the query, is contradictory to the query, or is neural. As an example, an input associated with the scene of FIG. 1 may be “Change the color to blue” where the follow on query would ask “What color?” Thereafter, the system may evaluate a number of potential colors, which may correspond to values for an associated entity, in this instance color. The color “blue” may then be selected from the potential colors, if available, and then used to populate a slot, which provides an action for the system to follow, in this instance the action would be rendering the object in the color blue.

In at least one embodiment, the command to update or change the scene is transmitted to the interaction environment 206, which may be a direct transmission from the speech entity 208 or from the local client 204. The interaction environment 206 may then affect the change by performing the action and, in various embodiments, may provide a confirmation of the action, such as providing an auditory response indicating the action is complete. Additional interactions may then repeat the process with different intents, slots, entities, and values being identified, populated, and then having actions performed.

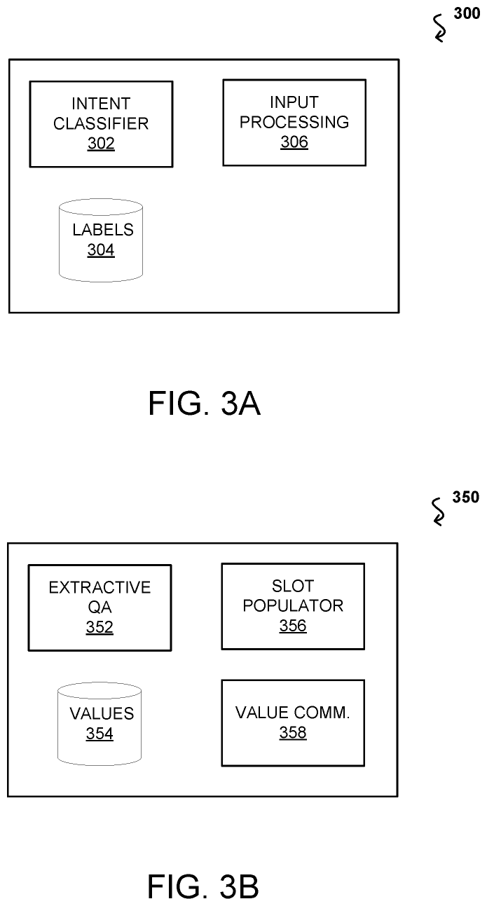

An intent classification system 300 may form at least a portion of speech entity 208, as shown in FIG. 3A. It should be appreciated that the intent classification system 300 may include more or fewer components and that the current embodiment is shown for illustrative purposes only. In this example, an intent classification system 300 includes a classifier 302, which may be a portion of a trained neural network. In various embodiments, the classifier 302 utilizes one or more zero-shot approaches (e.g., zero-shot learning) to predict classes associated with user inputs based, at least in part, on training data. As will be appreciated, classes used to train the system may be different from the classes (e.g., intents) utilized during operation of the system. In various embodiments, the intent classifier 302 receives, as an input, one or more words or word sequences, which may have undergone one or more preprocessing steps, and then determines a probability that the word or word sequence belongs to one or more intents classifications (e.g., labels). A highest probability score may then be selected for classifying the word or word sequences. Moreover, it should be appreciated that one or more thresholds may further be established for classification, where a probability that does not exceed a threshold, while still being a highest among a group, is not classified into the highest probability label.

In various embodiments, labels may be defined by one or more users or operators of the system, or may be predefined, and may be stored in a label data store 304. Labels may be provided to the system by an entity operating or presenting the system to users, where the labels are selected, at least in part, on the interaction environment being presented. By way of example only, with interaction environment of FIG. 1 is associated with an automobile, so labels may be associated with changing a color, changing a camera angle, and the like. However, these labels may be particularly selected for this particular interaction environment, as a label associated with an action such as “inserting a bush” or a “adding a wall” would not make sense or be related to the interaction environment. Accordingly, systems and methods may be utilized to establish specific labels for specific actions based, at least in part, on the interaction environment. As will be described, classifying certain actions within a label problems improved flexibility to the system, where specific training examples are not used for a specific environment, but rather, the zero-shot approach allows a trained system to then adapt to various different user-provided labels.

As noted above, the input provided by the user maybe processed via one or more processing systems 306, which may include or be associated with one or more audio or textual processing systems, such as a natural language understanding (NLU) system 106 to enable humans to interact naturally with devices. The NLU system may be utilized to interpret context and intent of the input to generate a response. For example, the input may be preprocessed, which may include tokenization, lemmatization, stemming, and other processes. Additionally, the NLU system may include one or more deep learning models, such as a BERT model, to enable features such as entity recognition, intent recognition, sentiment analysis, and others. Moreover, various embodiments may further include automatic speech recognition (ASR), text-to-speech processing, and the like. One such example of these systems may be associated with one or more multimodal conversational AI services, such as Jarvis from NVIDIA Corporation.

A selection system 350 may form at least a portion of speech entity 208, as shown in FIG. 3B. It should be appreciated that the selection system 350 may include more or fewer components and that the current embodiment is shown for illustrative purposes only. In this example, a selection system 350 includes an extractive question answer model 352, which may be a trained neural network that is utilized to extract one or more portions of an input sequence to answer a natural language question associated with such a sequence. As noted above, for an input such as “paint the car blue” an intent may be determined as “related to car color” with the question being “what color?” In this example, the extractive question answer model 352 could then be utilized to answer the question of “what color,” which in this case would be “blue.” In various embodiments, the extractive question answer model may be a trained neural network system, such as Megatron from NVIDIA Corporation.

In various embodiments, a user or operator may populate a values data store 354 that includes a variety of different potential values for populating associated slots, which may be further related to different intents and/or questions associated with those intents. By way of example only, an intent may be related to changing a color, an associated slot may be a color, a question for that slot may be “which color?” and slot values may include different potential colors, such as white, red, black, blue, green, etc. Accordingly, a provider may enable predefined or predetermined configurations that may be rendered responsive to an input from the user. In at least one embodiment, a slot populator 356 determines which value, from the values data store 354 to populate the slot associated with the question, which leads to performance of one or more actions. Returning to the previous example, if the user had said “change the color to black,” the system would interpret intent to be related to changing a color, the slot associated with color, a question of “which color,” and then select from the slot values to identify black as a potential value and the populate an associated slot with “black.” Thereafter a value communicator 358 may proceed with transmitting information to the interaction environment to enable performance of the action associated with the input.

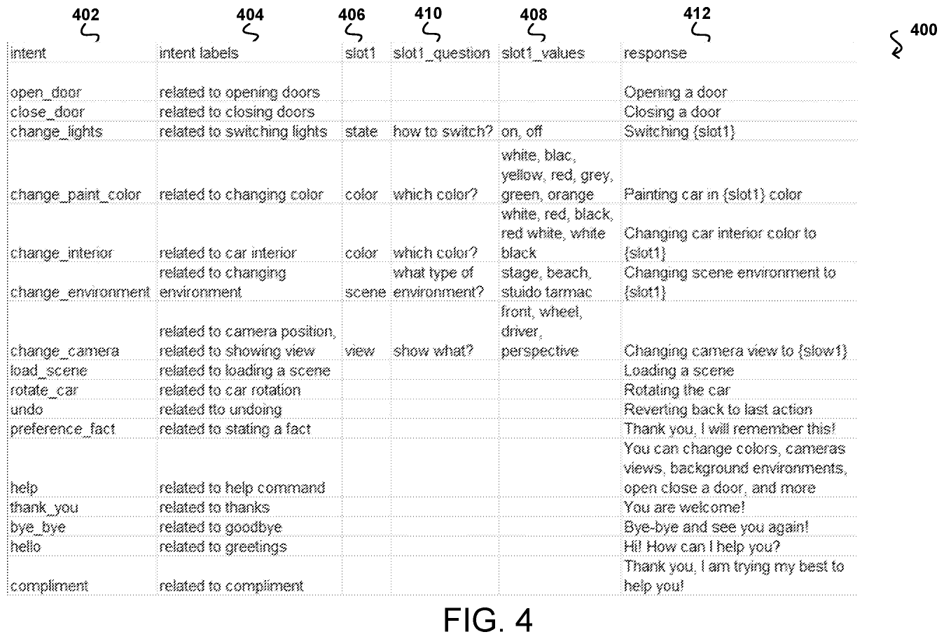

In at least one embodiment, command definitions 400 may be provided as an input to the interaction environment, as shown in FIG. 4. It should be appreciated that while the command definitions 400 are shown as a slot and intent table for the illustrated embodiment, various other types of data inputs and configurations may be provided with embodiments of the present disclosure. In this example, intents 402 are illustrated in a first column and their associated intent labels 404 are shown in a second column. As previous discussed, the intents may be related to one or more actions corresponding to an input provided by a user. By way of example, the intent may be associated with an action, such as opening a door, with an associated label such as “related to opening doors.” In at least one embodiment, a user may provide the command definitions 400 and may, in various embodiments, update the definitions in near-real time or at run time, which provides improved flexibility for the system.

As shown, intent labels 404 may be related to associated slots 406, which may be populated with one or more values from the slot values 408. In at least one embodiment, slot values 408 are determined based, at least in part, on their ability to answer a question with respect to the slot question 410. That is, upon determining the intent, the extractive question answer model may then formulate a question, where an answer to the question is determined based, at least in part, on the input. Thereafter, a value may be selected from the slot value 408 and populated into the slot 406. Accordingly, an associated response 412 may be provided to the user, along with a command to an interaction environment to proceed with executing the user's query.

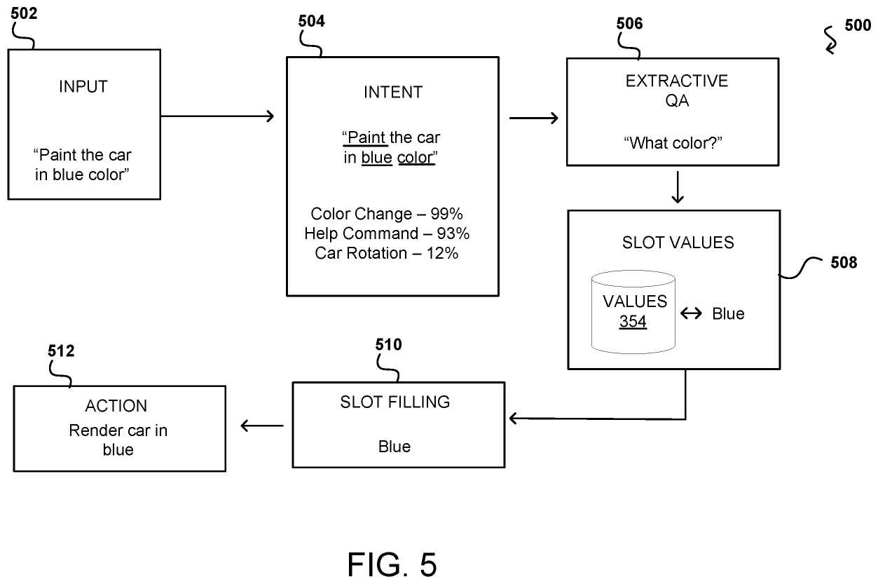

A process flow 500 to extract an intent from a query, determine a responsive question, populate a slot with a value, and perform an action is illustrated in FIG. 5. In at least one embodiment, various software modules may be utilized to perform different steps of the illustrated flow, where one or more components may be hosted locally on a local client or may be accessible via one or more networks, such as at a remote server or as a portion of a distributed computing environment. In this example, an input 502 starts the flow, which corresponds to a user utterance of “Paint the car in blue color.” This utterance may be responsive to the user interacting with an environment showing an image or rendering of a car, such as the environment shown in FIG. 1. The input may be received by one or more local clients, for example via a microphone, and may be further processed either on the local client or using one or more remote systems.

Various embodiments extract an intent 504 from the input 502. In this example, intent may be determined by evaluating one or more portions of the utterance, such as word or word phrases, via one or more trained machine learning systems. For example, the utterance may be evaluated and one or more keywords or phrases may be extracted, which may be utilized to determine an intent. The intent may be associated with a predetermined or pre-loaded intent, such as one provided by a provider of the system, where the intents may correspond to one or more capabilities of the systems. The intent 504 may be determined by classifying the utterance based, at least in part, on a probability the intent is associated with one or more labels. In this example, certain phrases are utilized to determine the intent, such as “paint,” “blue,” and “color,” to provide a high probability that the input 502 is associated with a label corresponding to “color change.” Accordingly, follow on actions according to the determined label may be performed, as further illustrated.

The determined intent may be processed by an extractive question answer model 506. For example, the model 506 may process a question, in natural language, responsive to the intent. In this example, the question is “What color?” and the answer may be extracted from the initial input, which is “blue,” as shown in the slot values step 508. The answer may then be compared to one or more values, such as from the values data store 354. If there is a match, then the value may be utilized for slot filling 510. For example, the “slot” may correspond to a value that within a command to perform one or more actions 512, which in this example, is to render the car in a blue color. Subsequent inputs may be further processed to determine intents, associated questions, and slots. In at least one embodiment, additional tools may be provided where an intent is not determinable, such as a help function that requests additional information.

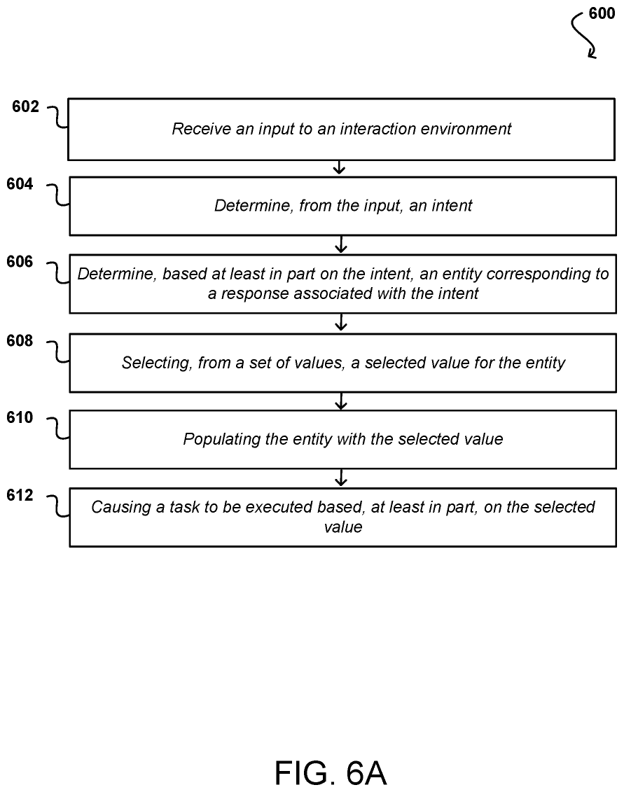

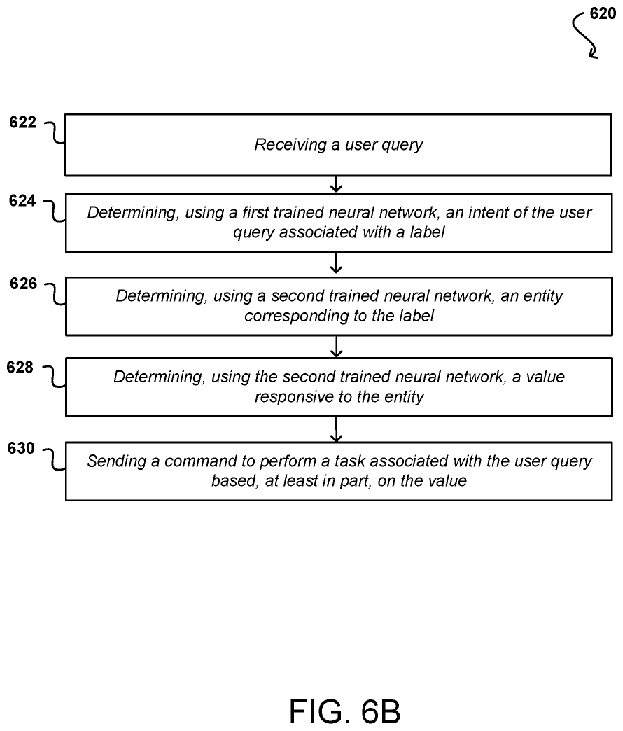

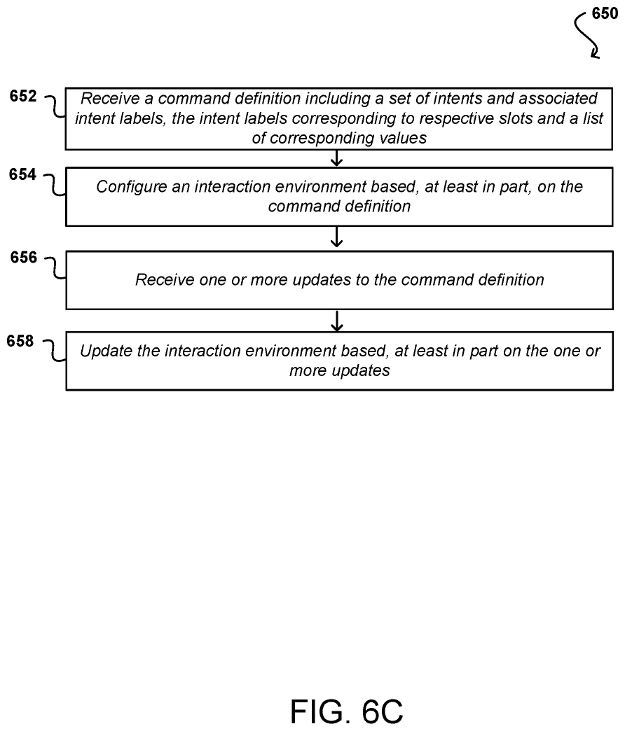

FIG. 6A illustrates an example process 600 for determining a user intent to execute an action within an interaction environment. It should be understood that for this and other processes presented herein that there can be additional, fewer, or alternative steps performed in similar or alternative order, or at least partially in parallel, within the scope of various embodiments unless otherwise specifically stated. In this example, an input is received at an interaction environment 602. The input may be a voice input, such as an utterance provided by a user. It should be appreciated that inputs may also include an audio recording, an audio segment extracted from a video, a textual input, or the like. An intent may be determined from the input 604. In at least one embodiment, the intent is evaluated using a zero-shot approach and a probability for an intent is determined. The probability may be evaluated against a list of pre-determined intent labels, which the labels are provided by a provider associated with the interaction environment.

In various embodiments, an entity associated with the intent is determined 606. The entity may correspond to a slot within a table that may be populated in order to determine a response to the input. In at least one embodiment, the entity is determined based, at least in part, on an extractive question answer model where a question is proposed responsive to the user input and an answer to satisfy the slot is determined The entity have a list of potential associated values, where a value is selected based, at least in part, on the input 608. The selected value may be used to populate the entity 610 such that a task can be executed responsive to the input 612.

FIG. 6B illustrates an example process 620 for determining a user intent and associated value to perform an action. In this example, a user query is received 622. As noted, the user query may be an auditory input, among other options. A first trained neural network may be used to determine an intent of the user query 624. In at least one embodiment, the trained neural network utilizes a zero-shot approach where one or more features of the query are evaluated to determine a probability that the intent is related to one or more pre-defined intent labels. In at least one embodiment, a second trained neural network may determine an entity associated with the label 626 and a value for that entity 628. The second trained neural network may utilize an extractive question and answer model to determine the appropriate entity, for example by formulating a question associated with the input, and then determining whether a value is supported from a list of pre-determined values. The value may be utilized to populate the entity so that a command may be transmitted in order to perform one or more actions associated with the user query 630.

FIG. 6C illustrates an example process 650 for configuring an interaction environment. In this example, a command definition for an interaction environment is received 652. The command definition may include a set of intents and associated labels for the intents. Moreover, in embodiments, each label may include a corresponding slot to be populated with one or more values from a list of corresponding values. The interaction environment may be configured based, at least in part, on the command definition 654. In at least one embodiment, the interaction environment is configured without training one or more machine learning systems with information associated with the command definition. That is, an existing trained model may be utilized that is not specially trained using the command definition. One or more updates to the command definition may be provided 656. Updates may include additional intents or labels, additional values, or the like. The interaction environment may be updated using the one or more updates 658. In at least one embodiment, the update is further done without updating or modifying the one or more machine learning systems associated with the interaction environment.

### Data Center

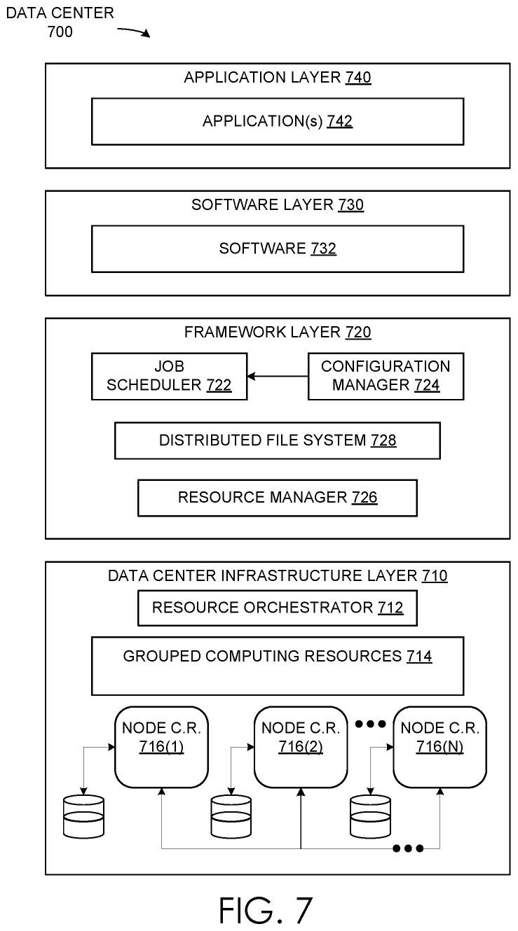

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used for executing commands in interaction environments.

### Computer Systems

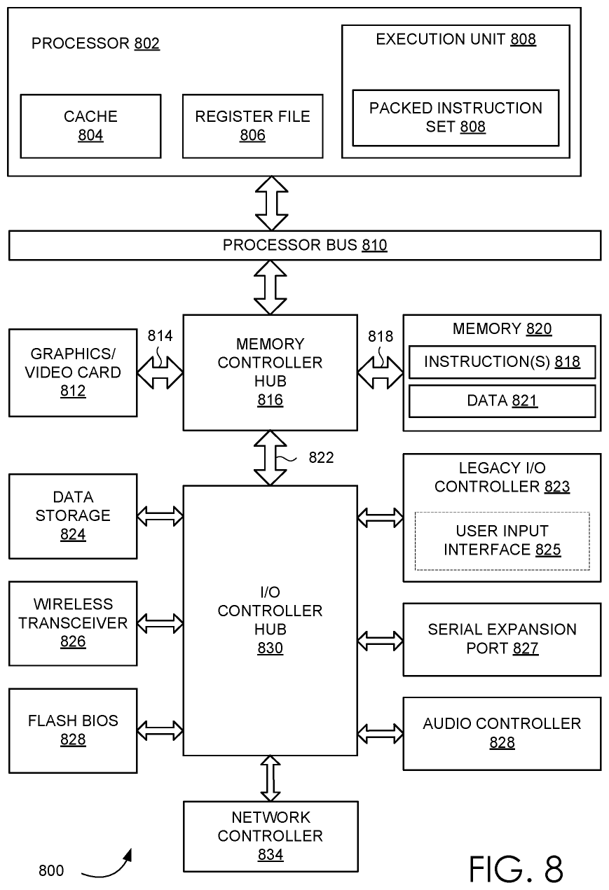

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, Calif., although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), edge computing devices, set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof In at least one embodiment, one or more components of computer system 800 are interconnected using compute express link (CXL) interconnects.

Such components can be used for executing commands in interaction environments.

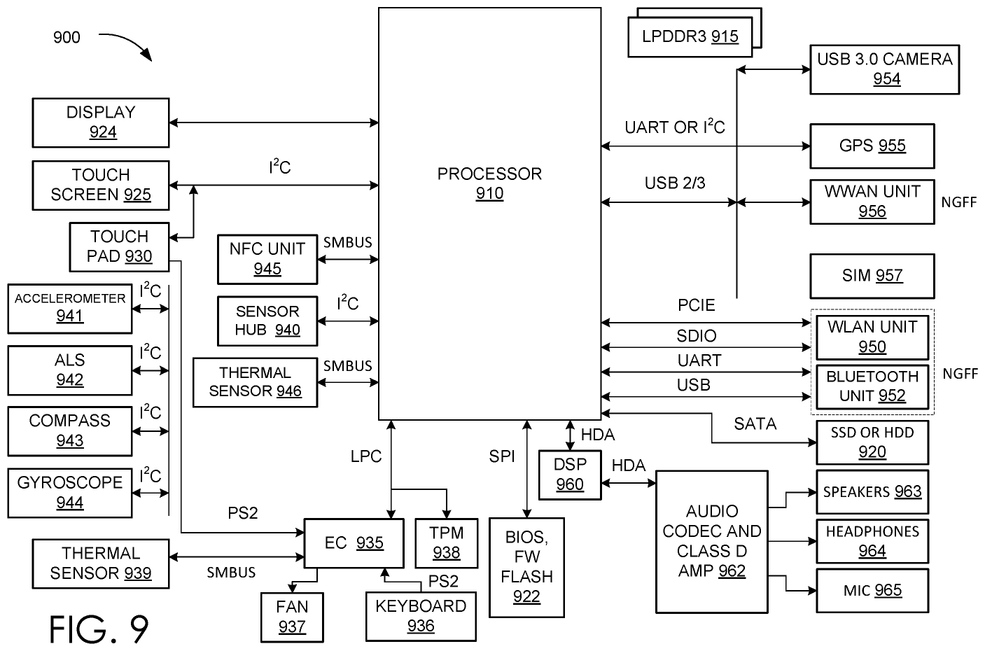

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 946, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used for executing commands in interaction environments.

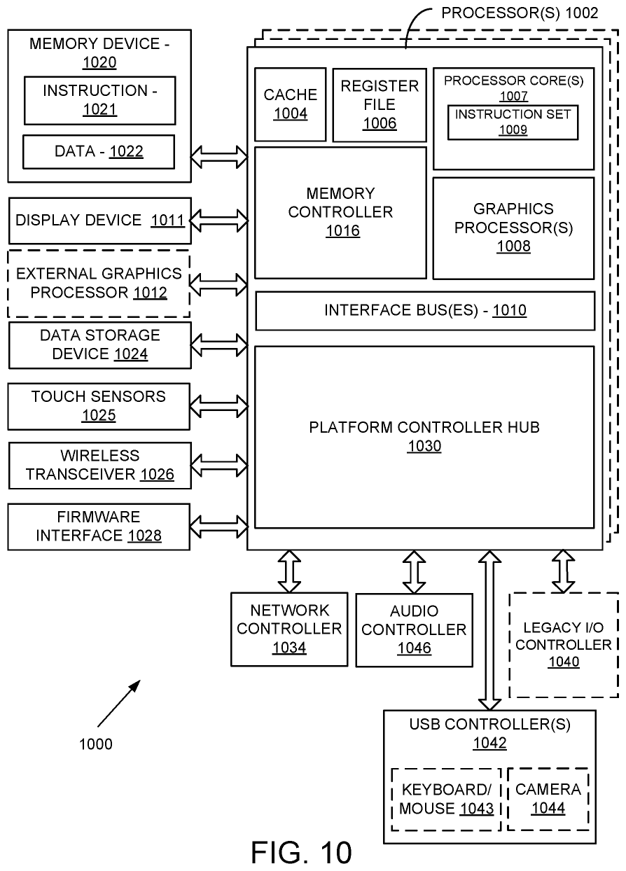

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system or datacenter having a large number of collectively or separably managed processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a cloud computing host platform, a virtualized computing platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, edge device, Internet of Things (“IoT”) device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used for executing commands in interaction environments.

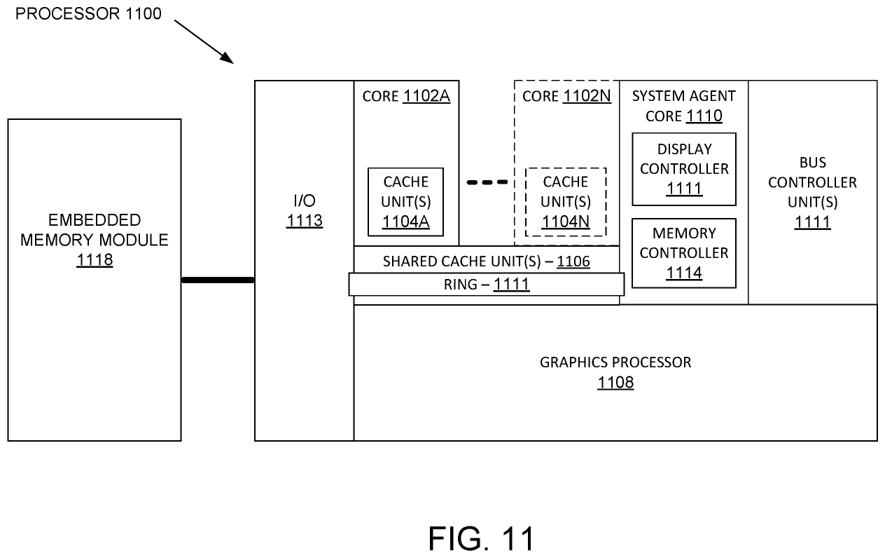

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used for executing commands in interaction environments.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, image signal processor (“ISP”), arithmetic logic unit (“ALU”), vision processing unit (“VPU”), tree traversal unit (“TTU”), ray tracing core, tensor tracing core, tensor processing unit (“TPU”), embedded control unit (“ECU”), and the like. As non-limiting examples, “processor” may be a hardware accelerator, such as a PVA (programmable vision accelerator), DLA (deep learning accelerator), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more processing units to:
determine an intent of a voice input, the intent being selected from a predetermined list of intents;
generate a formulation based, at least in part, on one or more features of the intent;
determine an entity associated with the intent, the entity corresponding to a response to the formulation associated with the intent;
select, from a predetermined list of entity values, a selected value; and
execute a task, responsive to the voice input, based, at least in part, on the selected value.

2. The processor of claim 1, wherein the one or more processing units are further to:
receive a plurality of intents, each intent of the plurality of intents having a respective label;
determine a probability, for each label, corresponding to the voice input; and
select one or more labels having the highest probability.

3. The processor of claim 1, wherein the one or more processing units are further to execute a trained entailment neural network, wherein the one or more processing units determine the intent of the voice input using the trained entailment neural network.

4. The processor of claim 3, wherein the one or more processing units are further to execute a trained extractive question and answer neural network model, wherein the one or more processing units are to select the selected value using the trained extractive question and answer neural network model.

5. The processor of claim 3, wherein the one or more processing units are further to provide, responsive to executing the task, a voice prompt.

6. The processor of claim 5, wherein the voice prompt includes a first portion corresponding to a predetermined prompt section and a second portion corresponding to the selected value.

7. The processor of claim 1, wherein the one or more processing units are further to:
receive one or more additional intents for the predetermined list of intents; and
add the one or more additional intents to the predetermined list of intents.

8. The processor of claim 7, wherein one or more machine learning systems are not retrained in response to the one or more additional intents being added to the predetermined list of intents.

9. The processor of claim 1, wherein the one or more processing units are further to:
receive a second voice input;
determine an intent, associated with the second voice input, does not correspond to the predetermined list of intents; and
provide a response that includes a request for additional information.

10. A method, comprising:
receiving a user query to perform a task;
determining, using a first trained neural network, a label corresponding to an intent of the user query;
determining, using a second trained neural network and based at least in part on the label, an entity query for the task associated with a formulation;
determining, using the second trained neural network, a value responsive to the entity query; and
transmitting an instruction to perform the task based, at least in part, on the value.

11. The method of claim 10, wherein the user query is an auditory input.

12. The method of claim 10, further comprising:
determining the label corresponds to a list of intent labels.

13. The method of claim 13, further comprising:
determining a probability of the label corresponds to at least one intent label of the list of intent labels; and
selecting the label based, at least in part, on a highest probability value.

14. The method of claim 10, wherein the second trained neural network is an extractive question and answer model.

15. The method of claim 10, further comprising:
providing, after performing the task, an auditory confirmation including, at least in part, the value.

16. A computer-implemented method, comprising:
determining an intent associated with an input query;
mapping the intent to an associated action;
determining a formulation associated with the intent;
determining, based at least in part on the formulation, an entity associated with the associated action is undefined;
determining the entity based, at least in part, on the input query;
executing the associated action.

17. The computer-implemented method of claim 16, wherein the entity includes a value, selected from a list of values.

18. The computer-implemented method of claim 16, wherein the input query is an auditory input, the computer-implemented method further comprising:
extracting, from the auditory input, one or more features associated with the intent.

19. The computer-implemented method of claim 16, wherein the intent is determined based, at least in part, on one or more machine learning systems using a zero-shot approach.

20. The computer-implemented method of claim 16, wherein the intent is selected from a list of intents, each intent of the list of intents corresponding to a respective intent label.
